(19) United States
(12) Patent Application Publication
(10) Pub. No.: US 2007/0156458 A1
(43) Pub. Date: Jul. 5, 2007

(54) Sieve of words in health-care data

(76) Inventors: Anuthep Benja-Athon, New York, NY (US); Nontawan Benja-Athon, Port Washington, NY (US)

Correspondence Address: ANUTHEP BENJA-ATHON, 210 E 36th St., NEW YORK, NY, 10016, US

(21) Appl. No.: 11/716,062

(22) Filed: Mar. 9, 2007

Related U.S. Application Data
(63) Continuation-in-part of application No. 11/649,873, filed on Jan. 5, 2007.
(63) Continuation-in-part of application No. 11/344,485, filed on Feb. 1, 2006.
(63) Continuation-in-part of application No. 11/293,689, filed on Dec. 5, 2005.
(63) Continuation-in-part of application No. 11/242,461, filed on Oct. 4, 2005.

(51) Int. Cl. G06Q 10/00; G06F 7/00

(52) U.S. Cl. 705/2; 707/7

(57) ABSTRACT

A system of selecting contents of health-care data on patients documenting actions or services performed by physicians wherein data are organized into categories and groups of data and wherein values are assigned to words and terms. The categories, groups and values are used to computer-automatically select contents of data.

This application is a continuation-in-part of Ser. No. 11/649,873 filed Jan. 5, 2007 entitled a system of calibrating physicians' practices of medicine, a continuation-in-part of Ser. No. 11/344,485 filed Feb. 1, 2006 entitled Physicians-patients-health-care-buyers accounting system, a continuation-in-part of Ser. No. 11/293,689 entitled System of conserving health-care buyers' resources filed Dec. 5, 2005, a continuation-in-part of Ser. No. 11/242,461 filed Oct. 4, 2005 entitled A perfect system of compensations for physicians which are pending.

### FIELD OF INVENTION

A system of selecting words and terms to benefit health-care consumers and buyers.

### BACKGROUND OF THE INVENTION

The health-care costs for hundreds of millions of health-care consumers and buyers and values to hundreds of thousands of American physicians are worth more than 2 trillion dollars per annum and growing. There are immense wastes, abuses and losses in billions of dollars per annum of said resources by said people and parties which no prior art effectively able to wring out to benefit said people and parties. As an intervention was heretofore interjected to address said waste, abuse or loss, another imposition or impositions was or were introduced to further perpetuate and escalate said wastes, abuses and losses. Consequently, health-care continue to be either costlier or unaffordable to all Americans resulting in lowering the quality of health and health-care, standard of living for Americans and reducing the competitiveness of American businesses.

The present invention provides a system and method resolves the above problems for Americans. The beneficial consequences of the present invention, therefore, for Americans and humanity are immense and beyond measure.

### SUMMARY OF THE INVENTION

A system of determining, finding or selecting contents of health-care data on patients documenting actions or services performed by physicians. Said data are organized into categories and groups of data comprising words, terms and phrases use in about 80 medical and surgical specialties and fields of practices. The present invention provides a system or method of ranking or assigning values to said words, terms, phrases and synonyms. Said categories, groups, words, terms, phrases and synonyms and values are used for computer-automatically selecting contents of said data.

### DESCRIPTION OF THE PREFERRED EMBODIMENTS

The pending patent applications of the present patent applicants taught the processes of organizing health-care data on patients generated by physicians and using categories and groups of said data for effecting health-care resources of health-care consumers, health-care buyers and revenues of physicians.

As a continuation-in-part of said pending patent applications, the present invention provides a system and method of using contents—categories and groups—in digital health-care data on patients generated by physicians wherein computer operating systems, programs and are used to determine, find or select said contents of data representing actions or services of said physicians. Therefore, one of the preferred embodiments of the present invention is a system and method for determining, finding or selecting contents of said data according to the spirit and scope of claims of the present invention.

Consequently, one of the preferred embodiments of the present invention provides a system and a method for computers, server or servers to determine, judge and select information present in two and more data on a patient in any period, moment, moments or periods of time such as, but not limited to, less than a day, a day, days, a week, weeks, a month, months, a year, years, any time in said periods of time or any combination thereof, comprise or contain same, similar, alike, exchangeable or variably described, related or equivalent words, terms, phrases, synonyms, etc. represent or result from same, similar, alike or equivalent determinations, actions and/or services performed by a physician or physicians on a patient.

The present invention uses identities of patients and physicians such as, but not limited to, first, middle and last names, dates of birth, titles and unique identifications distinguishing patients and physicians. Furthermore, the medical and surgical specialties of physicians are also used for identifying and distinguishing physicians.

The organizations of data infra are taught by the pending patent applications of the present patent applicants, however, the present invention teaches the values and applications of categories and groups of health-care data to achieve the objectives and goals of the present invention as follows:

First categories, columns or fields of fix data are such as, but not limited to, biographical information on patients and physicians and professional information on physicians or other health-care providers. Said data are such as, but not limited to, first, middle and last names, genders, dates of birth, titles, unique identifications, physical descriptions or data and biometrics such as, but not limited to, colors of hair, eyes, heights, finger prints, iris or retinal patterns or attributes and the like, etc., physicians' medical and surgical specialties, fields of practices or expertises in 80 medical and surgical specialties.

Second categories, columns or fields of semi-fix data such as, but not limited to, information on the time, dates of services provided by physicians to patients or dates of the generation of data by physicians or dates of transmissions of data generated by physicians into the network or networks of computers and servers.

Third categories, columns or fields of fix data comprise headings, such as, but not limited to, Chief Complaints, Evaluations or Contacts, Diagnosis, Test, Treatment, Procedure, Surgery.

Fourth categories, columns or fields of variable data associated with said third categories such as, but not limited to, category of chief complaints or symptoms, signs and manifestations; category of contacts with or services provide by physicians such as, but not limited to, consultations, office visits, follow-ups, examinations, evaluations, second opinions, etc.; category of diagnoses (plural of diagnosis), category of tests, category of treatments, category of procedures, category of surgeries. Said categories further comprise corresponding groups of chief complaints or symptoms, signs, manifestations, groups or clusters of diagnoses, groups or clusters of treatments, groups or clusters of procedures and groups or clusters of surgeries.

Said categories and groups comprise words, terms, phrases present in medical and surgical dictionaries, texts and thesauruses in about 80 medical and surgical specialties and practices of medicine and surgery. Said categories comprising tens to hundreds of thousands of groups or clusters. Therefore, said categories are generated and implemented for about 80 medical and surgical specialties and practices of medicine and surgery.

Furthermore, each group or cluster comprising one, two, a few, several or many words, terms, phrases, synonyms or any combination thereof are generated and implemented for about 80 medical and surgical specialties. According to supra, each group or cluster comprises said words, terms, phrases including same, similar, alike, equivalent words, terms, phrases and synonyms.

For example:
in a group of contact, an office visit is similar to an evaluation;
in a group of chief complaints a headache is same as head pain and may be related to meningitis;
in a group of diagnosis, scleroderma, systemic sclerosis, a connective tissue disorder (CTD), an autoimmune disorder (AD) are related in that scleroderma is synonym of systemic sclerosis and is a CTD and an AD or CTD and AD encompass scleroderma or systemic sclerosis;
in a group of test, an electrodiagnosis is same, similar or equivalent in the spirit of the present invention as electromyography, nerve conduction studies, EMGINCV, EMG and NCV;
in a group of treatment, acupuncture is same as percutaneous nerve stimulation, or a massage is same as trigger point release, myofascial release, soft tissue mobilization, etc.; and
in a group of procedure, a venous blood drawing is same as venupuncture; in a group of surgery, a gallbladder removal is same as cholecystectomy.

It is understood that said categories are not limited to supra as more categories comprising groups or clusters of words, terms, phrases, synonyms or any combination thereof can and will be created and applied—for and of 80 medical and surgical specialties and practices of medicine and surgery—to achieve the objectives and goals of the present invention.

Further to supra, the present invention provides a system and method of ranking said words, terms and phrases. By assigning a score, rank value or priority to each word, term, or phrase representing how relevant said word, term or phrase is to another word, term, phrase or synonym and/or other words, terms, phrases and synonyms in a group of data or groups of data for achieving the goals and objectives of the present invention. Therefore, the present invention provides a system and method of enhancing the efficiency of the system and method of the present invention for optimally achieving the goals and objectives of the present invention.

It is to be understood that a simplified description infra represents one of the preferred embodiments of the present invention which provides the use said categories and groups to achieve the goals and objectives of the present invention. In other words, said first-fourth categories of data and their groups of words, terms, phrases including synonyms in about 80 medical and surgical specialties and practices of medicine and surgery and said application of ranking or assignment of values to said words, terms, phrases and synonyms and said computer programs and languages and derivatives infra are used to achieve the goals and objectives of the present invention. For example, <Specialties><Dates><Contacts><CCs><Dx's><Rx's><Px's><Sx's> are some of said categories—comprising said groups of data as described supra—representing one of the preferred embodiments of the present invention can be used wherein Specialties are physicians' specialties of which there are about 80 medical and surgical specialties, Dates are dates in 12 months of a year or dates of services, Contacts are described supra, CCs are chief complaints, Dx's are diagnoses, Rx's are treatments, Px's are procedures, and Sx's are surgeries. It is to be understood that said categories can be less or more applied in the fulfillment of goals and objectives of the present invention.

An example of assignment of said score, rank value or priority is such as, but not limited to, a range of values between 0-1 or 1-100 to each word, term, phrase and synonym representing how relevant said word, term, phrase or synonym is to another word, term, phrase or synonym and/or other words, terms, phrases and synonyms, or vice versa, in a group of data or groups of data. For example, one of the preferred embodiments of the present invention, in a group of words, terms, phrases and synonyms comprises headache, headaches, head pain, head contusion, head concussion, head injury, throbbing head, encephalopathy, meningitis, encephalitis, meningoencephalitis, meningoencephalopathy, etc., said assignments of values can be schematically represented as follow:
headache 1
headaches 1
head pain 1
head contusion 0.8
head concussion 0.8
head injury 0.5
head trauma 0
throbbing head 1
encephalopathy 0
meningitis 0
encephalitis 0
meningoencephalitis 0
meningoencephalopathy 0
   or
connective tissue diseases 0
Systemic sclerosis 1
Scleroderma 1
Systemic lupus erythematosus 0
Dermatomyositis 0
Sjögren syndrome 0
Myofascial pain syndrome 0
Rheumatoid arthritis 0
Osteoarthritis 0

Said application of ranking or assignment of values serves to achieve the goals and objectives of the present invention applicable to words, terms, phrases and synonyms in said categories and groups and use in about 80 medical and surgical specialties and according to the science and practices of medicine and surgery.

In other words, said health-care data files on patients are organized, processed by and stored in the computers, server or servers using computer programs and languages infra according to the systems and methods taught by the pending patent applications and present application of the present patent applicants. Said data in categories and groups of data are compared, matched and/or ranked or values-assigned according to supra. Furthermore, data in categories and groups in subsequent data on patients are compared or matched with categories and groups in earlier data.

Health-care data files on patients generated by physicians are presented to computers, server and/or servers wherein the present invention said system and method for a computer, server or computers or servers to determine, detect or judge same, similar, alike, exchangeable or variably described, related or equivalent words, terms, phrases, synonyms, etc. present in data files on a patient generated by a physician or physicians and determine or judge if data in present in two or more data files on a given or any patient in a given period of time such as, but not limited to, within a day, a day, a week, a month or even a year or years, comprise or contain same, similar, alike, exchangeable or variably described, related or equivalent words, terms, phrases, synonyms, etc. representing or resulting from same, similar, alike or equivalent actions or services performed by a given physician or physicians on a given or any patient.

Further to supra, the present invention, therefore, achieves supra for data on health-care of thousands to millions of patients generated by tens or hundreds of thousands or millions of physicians and presented to said computer, server or computers or servers.

Said system and method provides a computerized process of distinguishing, determining, detecting and showing repetitions of health-care services provided by physicians to patients wherein digital health-care data on patients generated by physicians providing said services are received, analyzed, stored and analyzed in the computers or servers in a network or networks of computers and servers to produce outcomes, according to the spirit and scope of the claims of the present invention, viewable on an electronic means for displaying said outcomes such as, but not limited to, screens of computers, hand-held devices and televisions, by health-care consumers, health-care buyers and physicians.

It is to be understood that statistics and computations will be used to arrive at said system of ranking and assignment of values.

Said categories and groups and ranking are created according to supra and are implemented using various computer operating systems, programs and languages such as, but not limited to, a plurality of Microsoft operating systems and software (plural) such as, but not limited to SQL, SQL Server 2005 and derivatives, .NET framework and related software and programs, MySQL and derivatives, Oracle, and various languages such as, but not limited to scripting languages, php and perl and related and markup languages such as, but not limited to, XML and related are used to implement and achieve the goals and objectives of the present invention.

The outcomes of the present invention are used to influence health-care costs and expenses of health-care consumers and health-care buyers and revenues of physicians.

Although the preferred embodiments of the present invention emphasize on determining, detecting, identifying, judging, querying and/or selecting same, similar, alike, exchangeable, related or equivalent words, terms, phrases, synonyms in said health-care data files to achieve an objective and a goal of the present invention, it is to be understood that by the virtue of the present invention providing said ranking or assigning values to words, terms, phrases including synonyms use in all medical and surgical specialties and practices of medicine and surgery and employing said computer operating systems, programs and languages and their derivatives, the present invention, therefore, also provides means for producing derivatives or outcomes stemming from determining or selecting contents of health-care data on patients.

Although the preferred embodiments have been described, it will be appreciated by those skilled in the art that variations, additions and adaptations to the present invention can be made without departing from the spirit of the invention and the scope of the claims.

1. A computerized system for selecting contents of health-care data on patients generated by physicians representing or documenting actions or services performed by a physician or physicians on a patient wherein said data on health-care of said patient are presented to computers, server or servers and, similarly, wherein said system applies to the contents of health-care data on patients generated by physicians and presented to said computers or servers adaptable to produce outcomes viewable on an electronic means for displaying said outcomes by health-care consumers, health-care buyers and physicians comprises:
a process of applying identities of individual patients;
a process of applying identities of individual physicians;
a process of applying medical and surgical specialties of individual physicians;
a process of applying categories of data;
a process of categorizing data;
a process of identifying data belonging to categories of data;
a process of assigning data to categories of data;
a process of applying groups of data;
a process of identifying data belonging to groups of data;
a process of assigning data to groups of data;
a process of ranking words and terms;
a process of selecting data;
a process of displaying outcomes of said processes to patients on an electronic means for displaying said outcomes; and
a process of displaying outcomes of said processes to physicians on an electronic means for displaying said outcomes.

2. A computerized system for selecting contents of health-care data on patients generated by physicians representing or documenting actions or services performed by a physician or physicians on a patient, wherein, similarly, said system applies to select contents of health-care data on patients generated by physicians, wherein said data generated by physicians are presented to computers and server or servers wherein said data are organized into categories and groups of data adaptable to produce outcomes viewable on an electronic means for displaying said outcomes by health-care consumers, health-care buyers and physicians comprises:
a process of applying identities of individual patients;
a process of applying identities of individual physicians;
a process of applying medical and surgical specialties of individual physicians;
a process of applying categories of data;
a process of categorizing data;
a process of identifying data belonging to categories of data;
a process of assigning data to categories of data;
a process of applying groups of data;
a process of identifying data belonging to groups of data;
a process of assigning data to groups of data;
a process of ranking words and terms;
a process of selecting data;
a process of displaying outcomes of said processes to patients on an electronic means for displaying said outcomes; and
a process of displaying outcomes of said processes to physicians on an electronic means for displaying said outcomes.

3. A system of ranking words and terms use in medical and surgical specialties and the practices of medicine and surgery for determining or selecting contents of health-care data on patients generated by physicians representing or documenting actions or services performed by a physician and physicians on a patient, wherein, similarly, said system applies to determine or selecting contents of health-care data on patients generated by physicians and wherein said data generated by physicians are presented to computers and server or servers adaptable to produce outcomes viewable on an electronic means for displaying said outcomes by health-care consumers, health-care buyers and physicians comprises:
a process of applying identities of individual patients;
a process of applying identities of individual physicians;
a process of applying medical and surgical specialties of individual physicians;
a process of applying categories of data;
a process of categorizing data;
a process of identifying data belonging to categories of data;
a process of assigning data to categories of data;
a process of applying groups of data;
a process of identifying data belonging to groups of data;
a process of assigning data to groups of data;
a process of ranking words and terms;
a process of selecting data;
a process of displaying outcomes of said processes to patients on an electronic means for displaying said outcomes; and
a process of displaying outcomes of said processes to physicians on an electronic means for displaying said outcomes.
